(19) United States
(12) Patent Application Publication
(10) Pub. No.: US 2011/0214573 A1
(43) Pub. Date: Sep. 8, 2011

(54) APPARATUS FOR PRODUCING CEREAL PUFFS

(75) Inventor: Hyung-Seob KIM, Seoul (KR)

(73) Assignee: DELICE CO., LTD., Seongnam-city (KR)

(21) Appl. No.: 12/876,641

(22) Filed: Sep. 7, 2010

(30) Foreign Application Priority Data
Mar. 8, 2010 (KR) 10-2010-0020529
Aug. 6, 2010 (KR) 10-2010-0075928

(51) Int. Cl. A23L 1/18; A23P 1/14

(52) U.S. Cl. 99/323.4

(57) ABSTRACT

Provided is an apparatus for producing cereal puffs, which heats cereals under pressure by means of a continuous circulating operation, puffs the cereals several times by means of a multistage rising operation, and causes the puffed cereals, i.e. the cereal puffs, to stand by at a predetermined position, and then to be rapidly discharged in a forward direction. Thus, it is possible to process the cereal puffs in a uniform shape, and to discharge the cereal puffs in a constant direction. Further, it is possible to simultaneously produce a plurality of cereal puffs having a uniform shape by means of one heating and pressurizing operation in a single apparatus.

### CROSS-REFERENCE TO RELATED APPLICATION

This application claims the benefit of Korean Patent Application No. 10-2010-0020529, filed Mar. 8, 2010 and Korean Patent Application No. 10-2010-0075928, filed Aug. 6, 2010, the disclosure of which is hereby incorporated herein by reference in its entirety.

### BACKGROUND OF THE INVENTION

1. Field of the Invention

The present invention relates to an apparatus for producing cereal puffs, and more particularly, to an apparatus for producing cereal puffs, which heats cereals under pressure, and performs multistage upward movement to puff the cereals several times, thereby enabling a plurality of cereal puffs having a uniform shape to be produced at the same time, and which enables the cereal puffs to be discharged in a constant direction, thereby improving operational performance thereof.

2. Description of the Related Art

In general, apparatuses for producing cereal puffs are machines that heat a variety of cereals to a predetermined temperature under pressure to produce foods such as cereal puffs.

Such apparatuses are configured so that when a predetermined amount of cereals is input into and heated in a sealed mold, water vapor is expanded in the heated cereals, and thus pressure rapidly rises in the mold.

Here, these apparatuses are based on the principle that, when the sealed mold is instantaneously opened, the pressure is reduced to rapidly puff the cereals several times. One of the conventional cereal puff producing apparatuses based on this principle is disclosed in Korean Patent No. 10-0774998, which has been previously applied by and issued to the applicant of the present invention.

The previously applied cereal puff producing apparatus includes a body frame, a mold provided in the middle of the body frame that heats and puffs cereals, a cereal feed unit feeding the cereals, which are contained in a hopper installed on an upper portion of the body frame, to the mold, a driving unit driving the cereal feed unit and the mold, and a heating unit heating the mold.

Here, the mold is divided into an upper mold and a lower mold, and has a structure in which the upper mold moves up and down in the state where the lower mold is fixed.

In the cereal puff producing apparatus having this structure, first, the driving unit drives the cereal feed unit, and thus the cereal feed unit feeds the cereals contained in the hopper to the mold. Then, the cereals fed to the mold are heated to a predetermined temperature by the heating unit installed on the mold, so that a cookie such as a cereal puff is produced.

In detail, the driving unit is driven to open the mold, and thus the cereals contained in the hopper are fed to the mold by a predetermined amount. In the state where the upper mold moves up, the cereals are fed to the lower mold, and then the upper mold moves down. The cereals are pressurized between the upper and lower molds, and are simultaneously heated to a predetermined temperature by the heating unit.

Afterwards, the cereals heated to the predetermined temperature maintain their initial state under high pressure, and then the upper mold moves up. Thereby, the pressure is suddenly reduced and the cereals are instantaneously puffed in a predetermined shape and discharged in a forward direction. Then, a predetermined amount of cereals to be puffed are fed.

In this way, the conventional cereal puff producing apparatus discharges the cereal puffs in various shapes rather than in a uniform shape when the cereals are puffed. Of course, although the upper and lower molds are installed to produce the cereal puffs in a desired shape, the cereal puffs are not actually produced in a regular shape. Furthermore, the cereal puffs spring out in various directions due to the instantaneous release of pressure, and thus the discharge direction of the cereal puffs is irregular.

Further, the conventional cereal puff producing apparatus is designed to produce only the cereal puffs exceeding a predetermined size (a diameter of about 20 cm) from the heating and pressurizing operation. As such, the cereal puffs having a small size (a diameter of about 10 cm or about 5 cm) are not produced. Furthermore, a function of simultaneously producing the cereal puffs having such a small size is not offered.

### SUMMARY OF THE INVENTION

The present invention provides an apparatus for producing cereal puffs, which heats cereals under pressure by means of a continuous circulating operation, puffs the cereals several times by means of a multistage rising operation, and causes the puffed cereals, i.e. the cereal puffs, to stand by at a predetermined position, and then to be rapidly discharged in a forward direction, thereby enabling the cereal puffs to be processed in a uniform shape, and enabling the processed cereal puffs to be discharged in a constant direction.

Further, the present invention provides an apparatus for producing cereal puffs, capable of simultaneously producing a plurality of cereal puffs having a uniform shape by means of one heating and pressurizing operation in a single apparatus.

According to an aspect of the present invention, an apparatus for producing cereal puffs includes: a cereal feed unit located at an upper portion of a body and dispensing cereals by a predetermined amount; a cereal transfer unit located in the body, containing the cereals dispensed by the cereal feed unit, moving and discharging the cereals to and from a processing position, and sliding in forward and backward directions such that, when the cereals discharged from the processing position are processed and puffed into the cereal puffs, the cereal puffs are pushed and discharged to the outside; a cereal processing unit located on a front side of the body, moving up and down in multiple stages to receive the cereals when the cereals are transferred to and discharged from the processing position by the cereal transfer unit, and puffing the cereals through heat and pressure into a plurality of cereal puffs having a predetermined size; and a driving unit installed on the body, driven under control of a controller, and sequentially driving the cereal feed unit, the cereal transfer unit, and the cereal processing unit.

The cereal feed unit may include: a hopper located at the upper portion of the body, allowing the cereals to be input thereinto, and having a plurality of discharge ports in a lower surface thereof to dispense the cereals by a predetermined amount; and a cereal feed shaft rotatably installed on a lower side of the hopper and having a plurality of cereal containing recesses, each of which contains a predetermined amount of cereals discharged from the corresponding discharge port and then discharges the cereals to the cereal transfer unit.

The hopper may have a small or large number depending on the size and number of the cereal puffs into which the heated and pressurized cereals are puffed, and the cereal feed shaft may have a number corresponding to the hopper.

The cereal containing recesses may each be fitted with a capacity adjusting member having a predetermined thickness such that the capacity of the cereals can be adjusted. The capacity adjusting member may be fastened to the bottom of the cereal containing recess by a fastening member.

Further, the apparatus may further include a cereal guide frame installed below the cereal feed shaft to guide the cereals, which are discharged from the cereal containing recesses, down to transfer the cereals to the cereal transfer unit. Here, the cereal guide frame may include a small or large number of cereal guide holes such that, when the heated and pressurized cereals are puffed into the cereal puffs, the size and number of the cereal puffs are set.

The cereal guide frame having the small or large number of cereal guide holes may be selectively applied depending the size and number of the cereal puffs.

The cereal transfer unit may include: a first slide member capable of sliding in forward and backward directions of the body; a second slide member installed on top of the first slide member and having cereal containing holes vertically opened to contain the cereals fed by the cereal feed unit; and a first actuator simultaneously sliding the first and second slide members in the forward direction by means of a driving force of the driving unit, and returning the first slide member in the backward direction and then the second slide member from which the cereals are discharged in the backward direction.

The cereal containing holes may have a number corresponding to the small or large number of cereal guide holes.

The first actuator may include: a pair of first actuating rods connected to the respective first and second slide members at first ends thereof and installed to be movable in forward and backward directions; a pair of second actuating rods rotatably installed on the body via an axle and hinged with the second ends of the pair of first actuating rods at first ends thereof; a pair of first elastic members connected to the pair of second actuating rods at first ends thereof and performing an elastic action such that the pair of second actuating rods are independently returned in the backward direction; and a first rotary member raising and rotating the pair of second actuating rods in the forward direction and lowering one of the pair of second actuating rods first such that the first slide member is returned in the backward direction.

The first rotary member may include a first rotary shaft, and a pair of first cams that are installed on the first rotary shaft to be eccentrically rotated, simultaneously raise the pair of second actuating rods when rotated, and cause one having a small thickness in a rotational direction to lower one of the pair of second actuating rods first to return the first slide member in the backward direction first.

The cereal processing unit may include: a lower mold having cereal processing holes for receiving the cereals discharged from the cereal transfer unit; an upper mold liftably installed on an upper side of the lower mold and having first pressurizing pads to pressurize the cereals received in the cereal processing holes; a liftable member having second pressurizing pads that are installed to be liftable from a lower portion of the lower mold into the cereal processing holes, serve as bottom surfaces of the cereal processing holes when lowered, and cause the processed cereals to be located above the cereal processing holes when raised; a second actuator moving up and down the liftable member by means of a driving force of the driving unit; and a third actuator lowering the upper mold and then raising and returning the upper mold in multiple stages by means of a driving force of the driving unit.

The cereal processing holes may have a number corresponding to a small or large number of cereal containing holes, and the first and second pressurizing pads may have a number corresponding to the cereal processing holes.

The upper mold may be elastically supported by a second elastic member, and may be returned upward by the second elastic member.

The second actuator may include: a third actuating rod installed to be rotatable in the forward and backward directions, hinged to the liftable member at a first lengthwise end thereof, and having a guide axle(s) protruding from one or both axial faces of the second end thereof opposite the first end thereof; and a second rotary member installed to be rotatable in the forward and backward directions and guiding the guide axle to move the actuating rod in upward and downward directions when rotated.

The second rotary member may include: a second rotary shaft installed to be rotatable in the forward and backward directions; and a second cam installed on the second rotary shaft to be eccentrically rotated and having a guide slot(s), which has a predetermined length in a rotational direction, in one or both axial faces thereof in order to guide the guide axle to move the third actuating rod in upward and downward directions when rotated.

The third actuator may include: a fourth actuating rod installed to be rotatable in the forward and backward directions, hinged to the upper mold at a first lengthwise end thereof, and moving the upper mold in upward and downward directions; and a third rotary member installed to be rotatable in the forward and backward directions, raising the second lengthwise end of the fourth actuating rod to lower the upper mold when rotated, and then lowering the fourth actuating rod in multiple stages to raise and return the upper mold in multiple stages.

The fourth actuating rod may be coupled with a rotatable roller at a second end thereof.

The third rotary member may include: a third rotary shaft installed to be rotatable in the forward and backward directions; and a third cam installed on the third rotary shaft to be eccentrically rotatable and having first and second steps that are continuously formed along a circumference thereof in order to lower the second lengthwise end of the fourth actuating rod, which is raised by the eccentric rotation, in multiple stages.

The first step may be configured to primarily lower the second lengthwise end of the fourth actuating rod. The second step may be formed deeper than the first step, and be configured to secondarily lower the primarily lowered second lengthwise end of the fourth actuating rod.

The first step may be coupled with a pivotal member at one end thereof on the basis of a rotational direction to be eccentrically rotated in the opposite direction to the rotational direction. The pivotal member may be configured to be rotated toward the first step to come into contact with the second lengthwise end of the fourth actuating rod, to lower the second lengthwise end of the fourth actuating rod toward the first step, and to be returned to an original position thereof by a dead load.

The first step may include a first damping member on the bottom thereof to absorb a shock generated when the second lengthwise end of the fourth actuating rod is lowered.

The cereal processing unit may further include a damping device that absorbs a shock caused by the upper mold when the upper mold is raised.

The damping device may include a cylinder, on a lower portion of which a rod is retractably installed, and a second damping member installed on a lower end of the rod and contacting an upper face of the upper mold.

The upper and lower molds may be configured so that heating units subjected to temperature control by a controller are inserted thereinto.

The driving unit may include: at least one driving motor installed on the body and having a driving shaft on which a driving gear is installed; a plurality of driven gears installed to be rotated along with the first, second and third rotary shafts; chains connecting the driven gears with the driving gear of the driving motor to transmit a driving force; and at least one tension adjusting gear installed to be rotatable in the forward and backward directions and adjusting tension in close contact with one of the chains.

The body may include at least one long hole in one sidewall thereof which is directed to the installed directions of the chains. The tension adjusting gear may be installed to be able to be positioned in the long hole by fastening members.

The driven gears may each include a cradle recess in one axial face thereof, into which a coupling member is inserted.

The coupling member may include: a first pressing member divided into a large number of first pressing members along a circumference in the cradle recess and having a first slope inclined in a radial outward direction such that an inner circumference thereof is in contact with an outer circumference of the first, second or third rotary shaft; a second pressing member divided into a large number of second pressing members along a circumference in the cradle recess and having a second slope inclined in a radial inward direction corresponding to the first slope such that an outer circumference thereof is in contact with an inner circumference of the cradle recess; an inserting member having a ring shape, inserted between the first and second slopes, and including one or more fastening holes along a circumference thereof; and fastening members configured to push the first and second pressing members in opposite directions when inserted through the fastening holes and fastened between the first and second pressing members, and to press the cradle recess and the first, second or third rotary shaft.

As described above, in producing the cereal puffs having a constant shape by expanding the cereals in multiple stages, it is possible to puff the cereals into numerous cereal puffs having a uniform shape, and to improve a quality of the processed cereal puffs. Further, since the processed cereal puffs can be discharged in a constant direction, it is easy to collect the processed cereal puffs.

### BRIEF DESCRIPTION OF THE DRAWINGS

The above and other features of the present invention will be described in reference to certain exemplary embodiments thereof with reference to the attached drawings in which:

FIG. 1 is a perspective view illustrating an apparatus for producing cereal puffs according to the present invention;

FIG. 2 is a left side view of FIG. 1;

FIG. 3 is a right side view of FIG. 1;

FIG. 4 is a schematic cross-sectional view of FIG. 1;

FIG. 5 is a schematic cross-sectional view illustrating an assembly of a hopper and a cereal feed shaft;

FIG. 6 is a perspective view illustrating the structure of a cereal guide frame having a plurality of cereal guide holes;

FIG. 7 is a cross-sectional view of FIG. 6;

FIG. 8 is a perspective view illustrating the structure of a cereal guide frame having a plurality of cereal guide holes;

FIG. 9 is a cross-sectional view of FIG. 8;

FIG. 10 is an enlarged view illustrating the first cam of a cereal transfer unit in an apparatus for producing cereal puffs according to the present invention;

FIG. 11 is an enlarged view illustrating the second cam of a cereal processing unit in an apparatus for producing cereal puffs according to the present invention;

FIG. 12 is an enlarged view illustrating the third cam of a cereal processing unit in an apparatus for producing cereal puffs according to the present invention;

FIG. 13 is an enlarged side cross-sectional view illustrating a driven gear and a coupling member installed on the driven gear in an apparatus for producing cereal puffs according to the present invention; and

FIGS. 14 through 21 illustrate operation of an apparatus for producing cereal puffs according to the present invention.

### DETAILED DESCRIPTION OF THE INVENTION

The present invention will now be described more fully hereinafter with reference to the accompanying drawings, in which exemplary embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, when it is mentioned that a layer is disposed “on” another layer or a substrate, it means that the layer may be directly formed on the other layer or a third layer may be interposed therebetween. In addition, the thickness of layers and areas may be exaggerated for clarity. Like reference numerals designate like elements throughout the specification.

In describing the present invention, the following terms are defined in consideration of the functionality in the present invention, and thus it should not be understood as limiting technical components of the present invention.

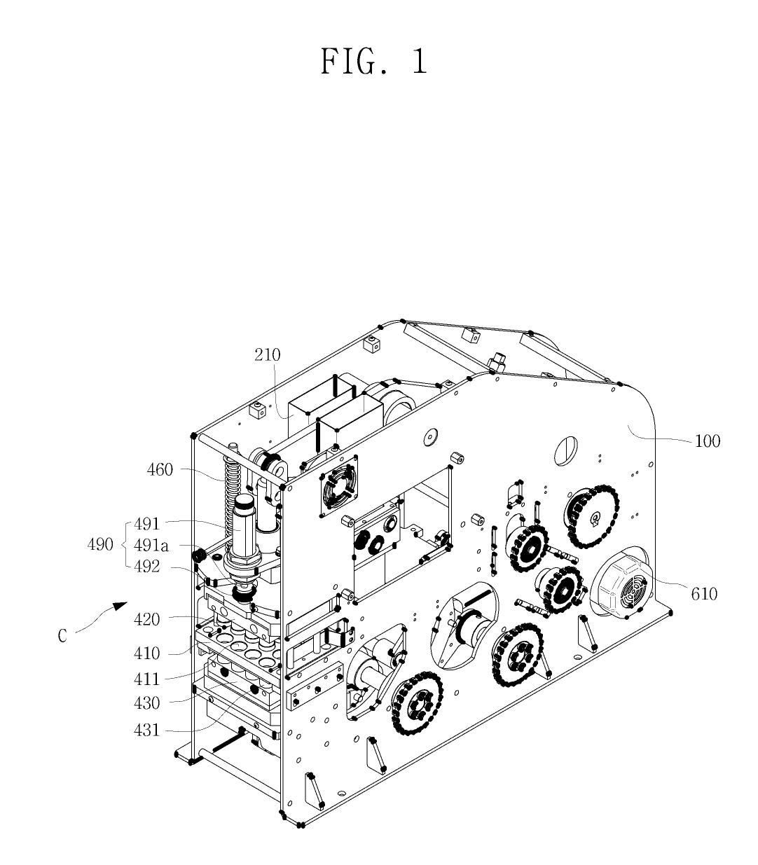

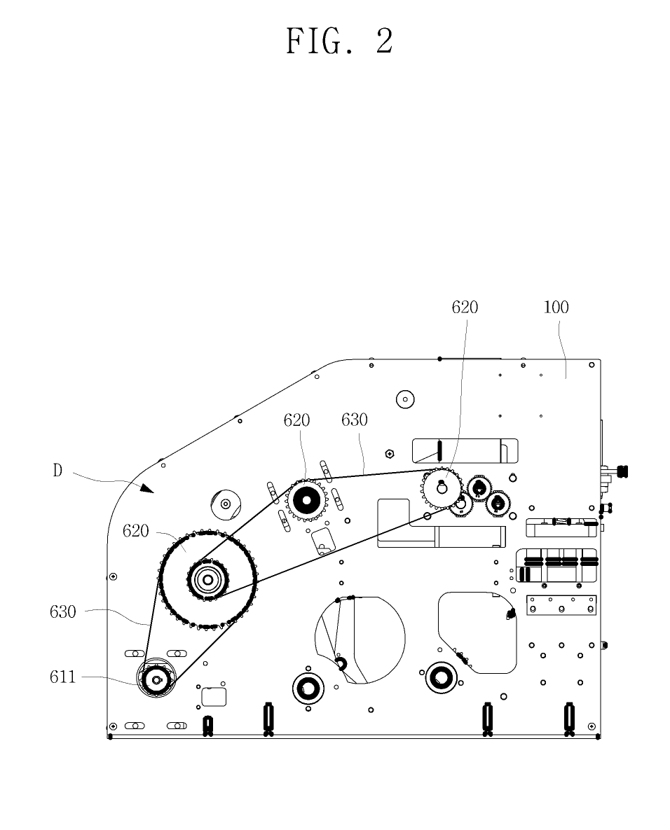

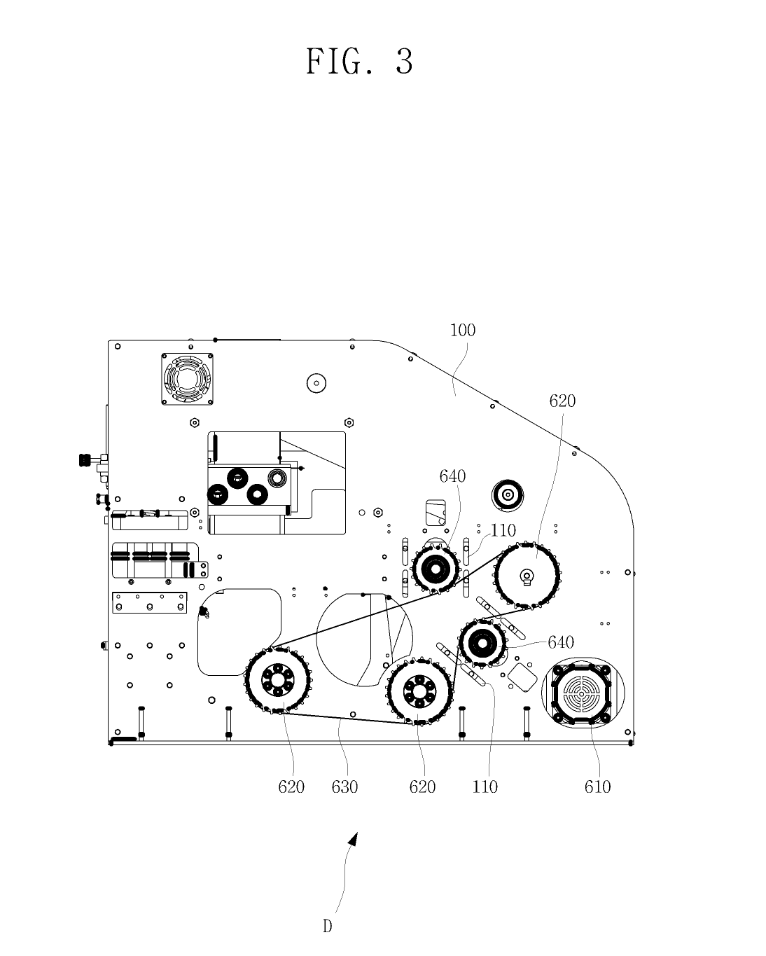

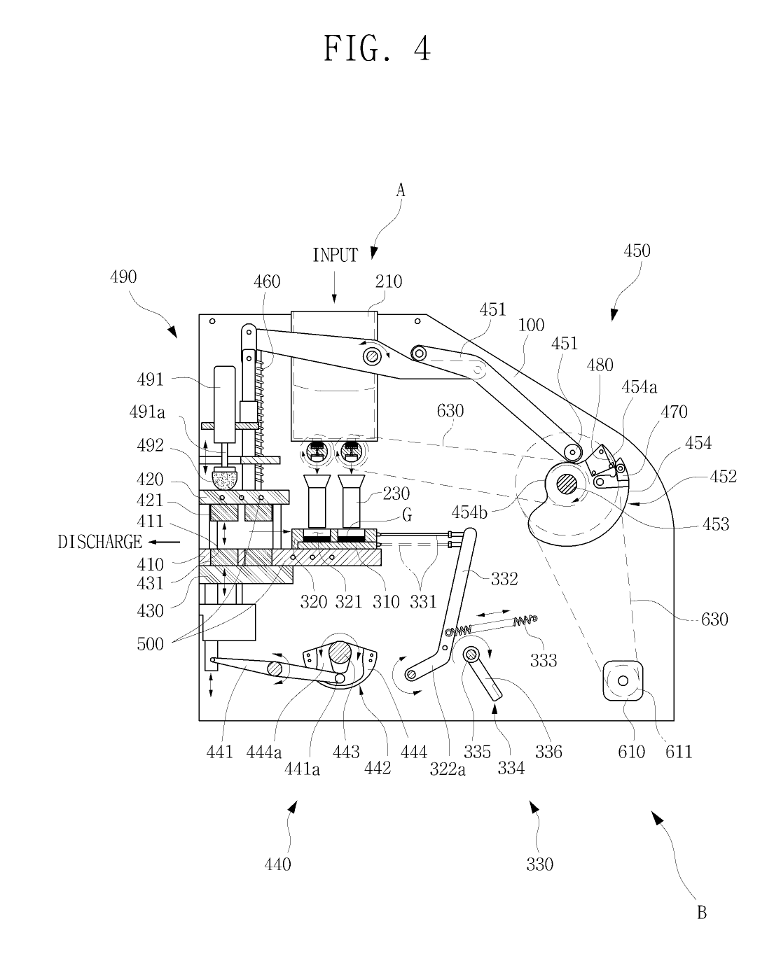

FIG. 1 is a perspective view illustrating an apparatus for producing cereal puffs according to the present invention. FIG. 2 is a left side view of FIG. 1, and FIG. 3 is a right side view of FIG. 1. FIG. 4 is a schematic cross-sectional view of FIG. 1.

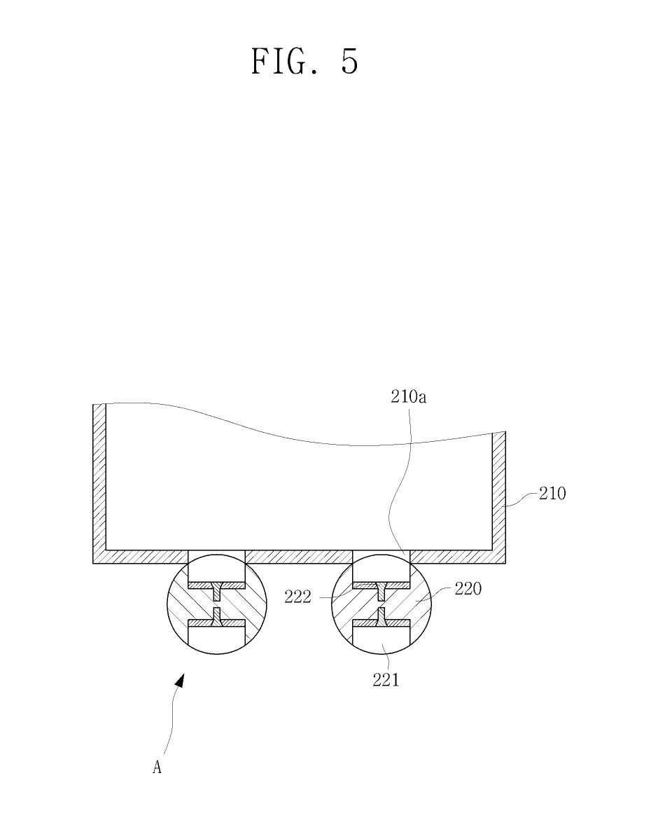

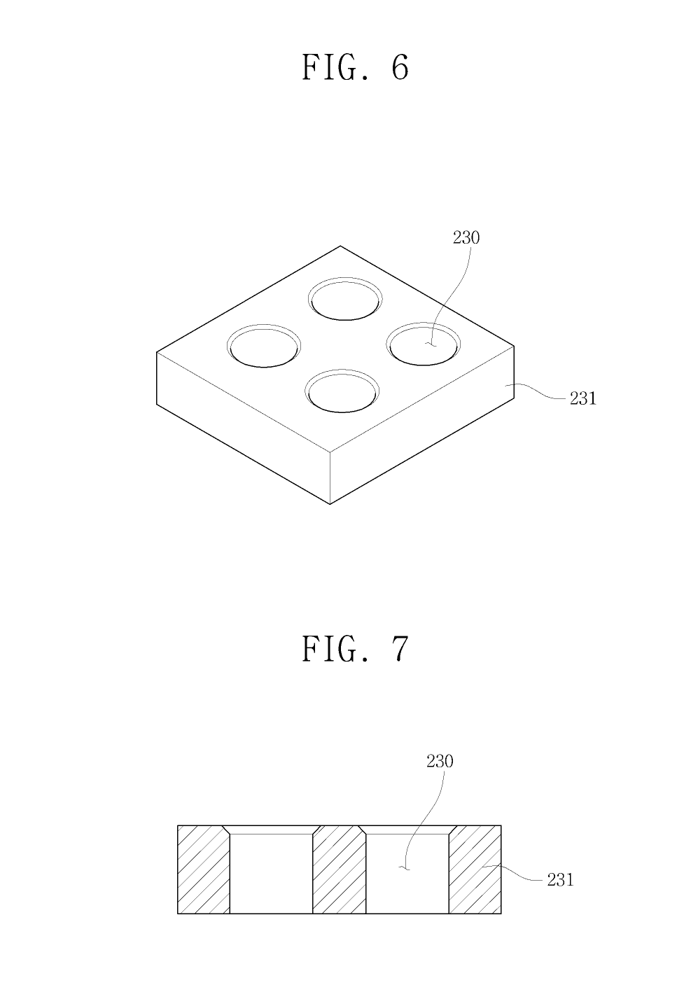

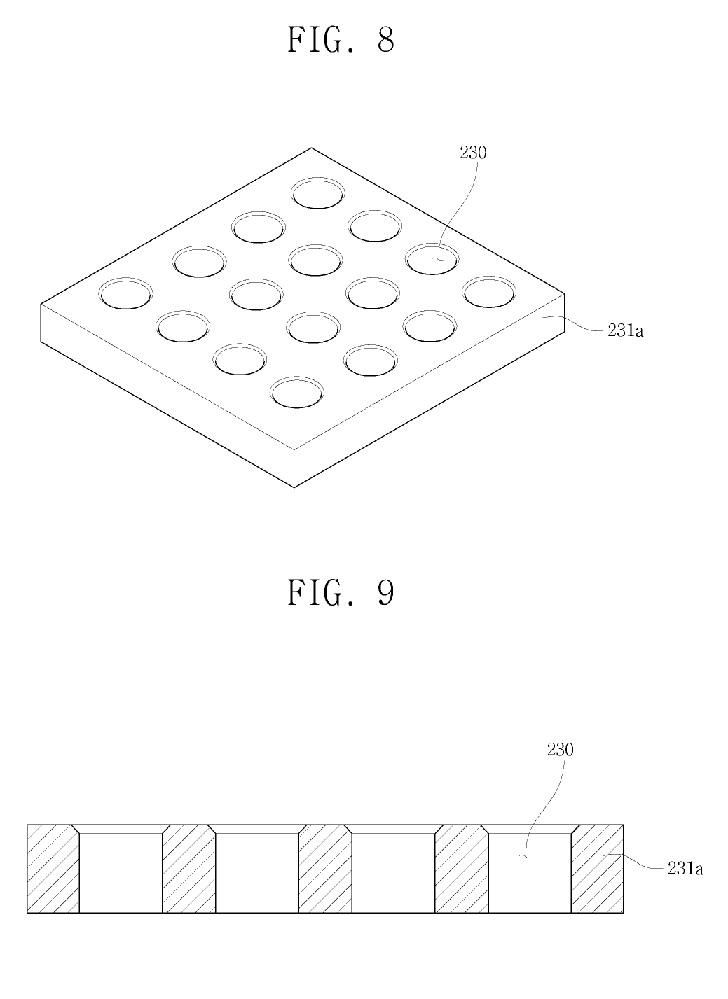

FIG. 5 is a schematic cross-sectional view illustrating an assembly of a hopper and a cereal feed shaft. FIG. 6 is a perspective view illustrating the structure of a cereal guide frame having a plurality of cereal guide holes. FIG. 7 is a cross-sectional view of FIG. 6. FIG. 8 is a perspective view illustrating the structure of a cereal guide frame having a plurality of cereal guide holes.

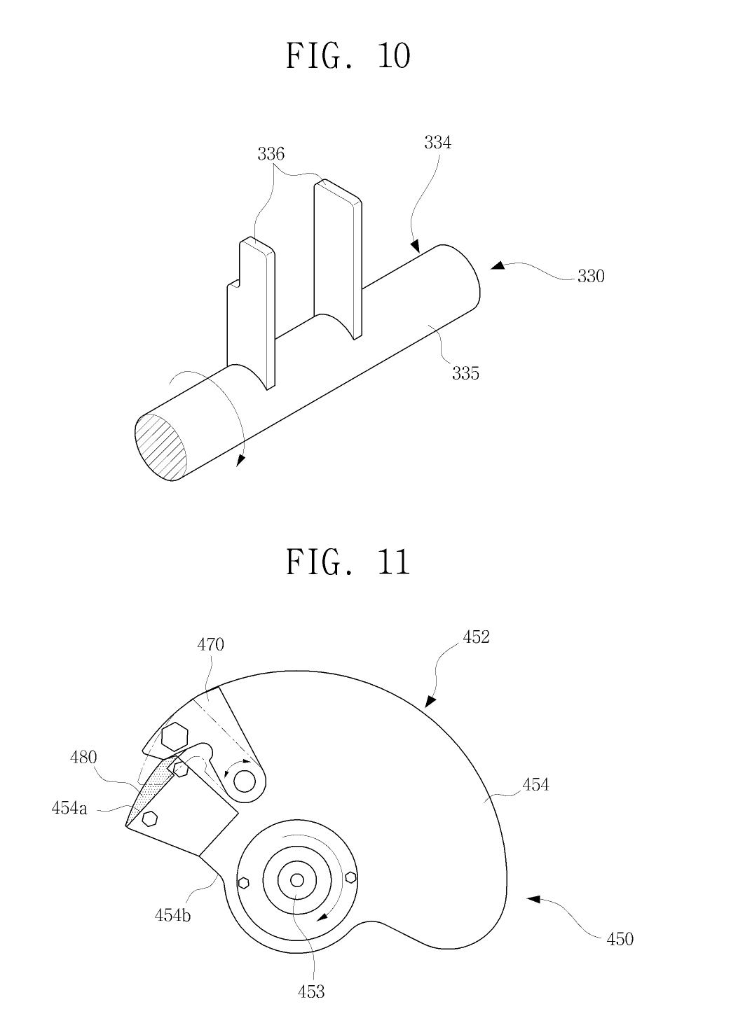

FIG. 9 is a cross-sectional view of FIG. 8. FIG. 10 is an enlarged view illustrating the first cam of a cereal transfer unit in an apparatus for producing cereal puffs according to the present invention. FIG. 11 is an enlarged view illustrating the second cam of a cereal processing unit in an apparatus for producing cereal puffs according to the present invention.

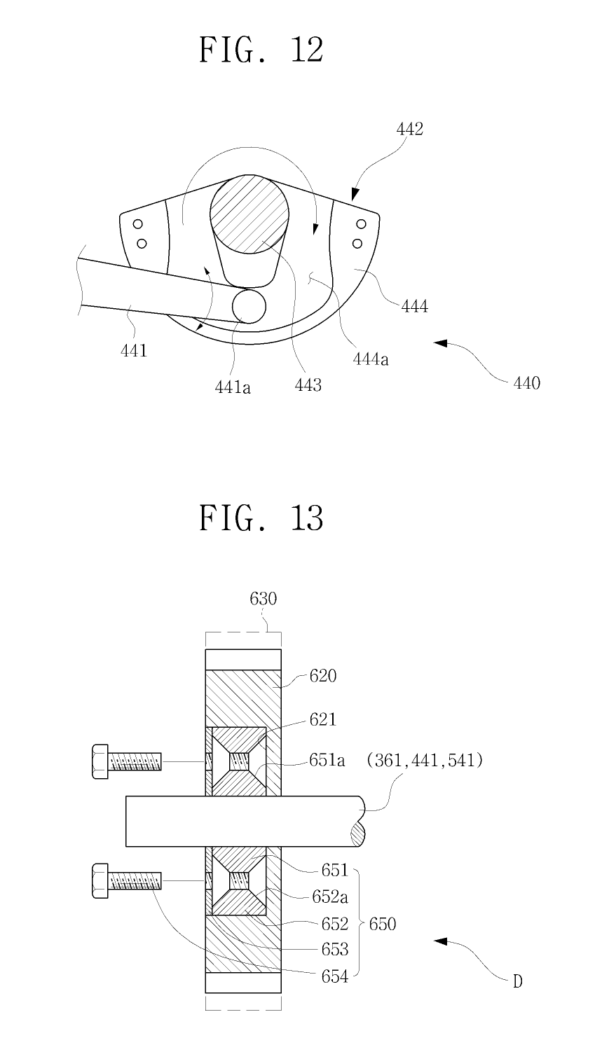

FIG. 12 is an enlarged view illustrating the third cam of a cereal processing unit in an apparatus for producing cereal puffs according to the present invention. FIG. 13 is an enlarged side cross-sectional view illustrating a driven gear and a coupling member installed on the driven gear in an apparatus for producing cereal puffs according to the present invention.

As in FIGS. 1 through 9, the apparatus for producing cereal puffs according to the present invention includes a cereal feed unit A, a cereal transfer unit B, a cereal processing unit C, and a driving unit D, all of which are components coupled to a body 100.

The cereal feed unit A is located at an upper portion of the body 100, dispenses cereals G such as rice, wheat, etc. by a predetermined amount, and feeds the dispensed cereals to the cereal transfer unit B. The cereal feed unit A includes a hopper 210, a cereal feed shaft 220, and a cereal guide frame 231 or 231a.

The hopper 210 is located at the upper portion of the body 100, allows the cereals G to be input thereinto, and is provided with a plurality of discharge ports 210a in a lower surface thereof to dispense the cereals by a predetermined amount.

Here, the hopper 210 may be installed in a small or large number depending on a size and number of the cereal puffs into which the heated and pressurized cereals are puffed.

Further, the hopper 210 is preferably configured to be tapered from an upper portion thereof into which the cereals G are input to a lower portion thereof. This allows the input cereals G to be fed with no loss.

The cereal feed shaft 220 is rotatably installed on a lower side of the hopper 210. The cereal feed shaft 220 is provided with a plurality of cereal containing recesses 221, each of which contains a predetermined amount of cereals discharged from the corresponding discharge port 210a and then discharges the cereals to the cereal transfer unit B. The cereal feed shaft 220 may be installed in the number corresponding to the hopper 210.

Here, a capacity adjusting member 222 having a predetermined thickness is fastened to the bottom of each cereal containing recess 221. A spatial volume of each cereal containing recess 221 is adjusted by fastening the capacity adjusting member 222, so that a capacity of the cereals G can be adjusted.

The cereal guide frame 231 or 231a is installed below the cereal feed shaft 220, and is configured to guide the cereals G, which are discharged from the cereal containing recesses 221, down to the cereal transfer unit B.

Here, the cereal guide frame 231 or 231a includes a small number of cereal guide holes 230 as in FIGS. 6 and 7 or a large number of cereal guide holes 230 as in FIGS. 8 and 9 such that, when the cereals are heated, pressurized and puffed into the cereal puffs, the size and number of the puffed cereals, i.e. the cereal puffs, are set. The cereal guide frame 231 or 231a having the small or large number of cereal guide holes 230 is selectively applied depending the size and number of the cereal puffs.

The cereal transfer unit B is located in the body, contains the cereals dispensed by the cereal feed unit A, and moves and discharges the cereals to and from a processing position. Further, when the cereals discharged from the processing position are processed and puffed into cereal puffs, the cereal transfer unit B pushes and discharges the cereal puffs to the outside. To this end, the cereal transfer unit B includes first and second slide members 310 and 320 sliding backwards and forwards by driving of the driving unit D, and a first actuator 330.

The first slide member 310 is configured to slide in the forward and backward directions of the body 100 when the driving unit D is driven. The first slide member 310 may be formed in a quadrilateral plate shape, and thus slides in contact with a horizontal plane formed in the body 100.

The second slide member 320 is installed on top of the first slide member 310, may be formed in a shape the same as or different from that of the first slide member 310, and is provided with cereal containing holes 321 vertically opened to contain the cereals fed by the cereal feed unit A.

Here, the cereal containing holes 321 may be formed in the number corresponding to the small or large number of cereal guide holes 230.

The first actuator 330 is configured to slide the first and second slide members 310 and 320 in the forward direction by means of a driving force of the driving unit D, and to return the first slide member 310 in the backward direction first and then the second slide member 320 from which the cereals G are discharged. The first actuator 330 includes first and second actuating rods 331 and 332, first elastic members 333, and a first rotary member 334.

The first actuating rods 331 are installed in a pair, are connected to the respective first and second slide members 310 and 320 at first ends thereof and to the second actuating rods 332 at the second ends thereof, and are configured to slide the first and second slide members 310 and 320 in the forward and backward directions.

Here, as for an operational sequence, the paired first actuating rods 331 simultaneously move toward the front of the body 100. However, when returned in the backward direction, one of the first actuating rods 331 is returned first, and then the other first actuating rod 331 is returned.

The second actuating rods 332 are rotatably installed on the body 100 via an axle 332a in a pair, hinged with the second ends of the paired first actuating rods 331 at first ends thereof, and configured to slide the first actuating rods 331 in the forward and backward directions.

The first elastic members 333 are springs that are connected to the paired second actuating rods 332 at first ends thereof, are fixed to the body 100 at the second ends thereof, and perform an elastic action such that the paired second actuating rods 332 can be independently returned in the backward direction.

As in FIG. 10, the first rotary member 334 raises and rotates the pair of second actuating rods 332 in the forward direction, lowers one of the pair of second actuating rods 332 first such that the first slide member 310 is returned in the backward direction, and includes a first rotary shaft 335 and first cams 336.

The first rotary shaft 335 is installed on the body 100 such that opposite lengthwise ends thereof can be rotated, and is configured to be rotated in the backward direction of the body 100 by the driving of the driving unit D.

The first cams 336 are installed on the first rotary shaft 335 to be eccentrically rotated, and are configured in a pair to simultaneously raise the pair of second actuating rods 332 when rotated, and then to cause one having a small thickness (cam having a cut upper side in FIG. 10) in a rotational direction to lower one of the pair of second actuating rods 332 first to return the first slide member 310 in the backward direction first.

The cereal processing unit C is located on a front side of the body 100, moves up and down in multiple stages to receive the cereals G when the cereals G are transferred to and discharged from the processing position of the cereal transfer unit B, and puffs the cereals heated and pressurized into a plurality of cereal puffs having a predetermined size. The cereal processing unit C includes a lower mold 410, an upper mold 420, a liftable member 430, and second and third actuators 440 and 450.

The lower mold 410 is provided with cereal processing holes 411 for receiving the cereals G discharged from the cereal transfer unit B. The cereal processing holes 411 are configured in the number corresponding to the small or large number of cereal containing holes 321.

Here, the small number of cereal containing holes 321 are different in diameter from the large number of cereal containing holes 321. Thus, the small or large number of cereal processing holes 411 have different diameters corresponding to the cereal containing holes 321. Thus, the cereal puffs can also have different sizes.

The upper mold 420 is liftably installed on an upper side of the lower mold 410, and has a small or large number of first pressurizing pads 421 that can be inserted into the cereal processing holes 411 to pressurize the cereals G received in the cereal processing holes 411.

Here, the upper and lower molds 420 and 410 are configured so that heating units 500 subjected to temperature control by a controller 660 are inserted thereinto.

The liftable member 430 has second pressurizing pads 431, which are installed to be liftable from a lower portion of the lower mold 410 into the cereal processing holes 411, serve as bottom surfaces of the cereal processing holes 411 when lowered, and cause the processed cereals to be located above the cereal processing holes 411 when raised.

Here, the first and second pressurizing pads 421 and 431 are configured in the number corresponding to the cereal processing holes 411.

Further, the upper mold 420 is configured to be elastically supported by a second elastic member 460, and to be able to be returned upward by the second elastic member 460.

The second actuator 440 raises the liftable member 430 by means of the driving force of the driving unit D, and includes a third actuating rod 441 and a second rotary member 442.

The third actuating rod 441 is installed to be rotatable in the forward and backward directions of the body 100, is hinged to the liftable member 430 at a first lengthwise end thereof, and has a guide axle(s) 441a protruding from one or both axial faces of the second end thereof opposite the first end thereof.

As in FIG. 12, the second rotary member 442 is installed to be rotatable in the forward and backward directions of the body 100, is configured to guide the guide axle 441a to move the actuating rod 441 in upward and downward directions when rotated, and includes a second rotary shaft and a second cam 444.

The second rotary shaft 443 is installed to be rotatable in the forward and backward directions of the body 100, and is configured to be rotated in the backward direction of the body 100 by the driving force of the driving unit D.

The second cam 444 is installed on the second rotary shaft 443 to be eccentrically rotated, and is provided with a guide slot 444a, which has a predetermined length in a rotational direction, in one or both axial faces thereof in order to guide the guide axle 441a to move the third actuating rod 441 in upward and downward directions when rotated.

Here, the guide slot 444a guides the guide axle 441a to be curved by forming a middle portion thereof to be lower than opposite sides thereof where the guide axle 441a comes in or out, so that the guide axle 441a coming in the guide slot 444a can repeat raising and lowering operations.

The third actuator 450 lowers the upper mold 420, and then raises and returns the upper mold 420 in multiple stages by means of the driving force of the driving unit D, and includes a fourth actuating rod 451 and a third rotary member 452.

The fourth actuating rod 451 is installed to be rotatable in the forward and backward directions of the body 100, and is configured to be hinged to the upper mold 420 at a first lengthwise end thereof and to move the upper mold 420 in upward and downward directions. The fourth actuating rod 451 is provided with a rotatable roller 451a at the second end thereof.

As in FIG. 11, the third rotary member 452 is installed to be rotatable in the forward and backward directions of the body 100, is configured to raise the second lengthwise end of the fourth actuating rod 451 to lower the upper mold 420 when rotated and then to lower the fourth actuating rod 451 in multiple stages to raise and return the upper mold 420 in multiple stages, and includes a third rotary shaft 453 and a third cam 454.

The third rotary shaft 453 is installed to be rotatable in the forward and backward directions of the body 100, and is configured to be rotated in the backward direction of the body 100 by the driving force of the driving unit D.

The third cam 454 is installed on the third rotary shaft 453 to be eccentrically rotatable, and has first and second steps 454a and 454b that are continuously formed along a circumference thereof in order to lower the second lengthwise end of the fourth actuating rod 451, which is raised by the eccentric rotation, in multiple stages.

The first step 454a is configured to primarily lower the second lengthwise end of the fourth actuating rod 451. The second step 454b is formed to be deeper than the first step 454a, and is configured to secondarily lower the primarily lowered second lengthwise end of the fourth actuating rod 451.

Here, a pivotal member 470 is installed on one end of the first step 454a on the basis of the rotational direction to be eccentrically rotated in the opposite direction to the rotational direction. The pivotal member 470 is configured to be rotated toward the first step 454a to come into contact with the second lengthwise end of the fourth actuating rod 451, and in this state, to lower the second lengthwise end of the fourth actuating rod 451 toward the first step 454a, and to be returned to its original position by a dead load.

In other words, the first and second steps 454a and 454b are configured to lower the upper mold 420 hinged to the first lengthwise end of the fourth actuating rod 451, and then to raise the upper mold 420 in two stages again.

The first step 454a is provided with a first damping member 480 on the bottom thereof which absorbs a shock generated when the second lengthwise end of the fourth actuating rod 451 is lowered.

Here, the cereal processing unit C further includes a damping device 490, which absorbs a shock caused by the upper mold 420 when the upper mold 420 is raised. The damping device 490 includes a cylinder 491, on a lower portion of which a rod 491a is retractably installed, and a second damping member 492 installed on a lower end of the rod 491a and contacting an upper face of the upper mold 420.

Here, the second damping member 492 supports the upper portion of the upper mold 420 that is instantaneously raised, so that it can reduce vibration and noise caused by a shock and simultaneously prevent each device of the cereal puff producing apparatus from being damaged. Thus, the second damping member 492 may be formed of soft rubber, synthetic resin, or the like.

As in FIGS. 2 and 3, the driving unit D is installed on the body 100, driven under control of the controller 660, and configured to sequentially drive the cereal feed unit A, the cereal transfer unit B, and the cereal processing unit C. The driving unit D includes a driving motor 610, driven gears 620, chains 630, and a tension adjusting gear 640.

The driving motor 610 is driven under control of the controller 660, is installed on the body 100, and has a driving shaft to which a driving gear 611 is coupled. Alternatively, a plurality of driving motors may be installed on the body 100.

The driven gears 620 are installed to be rotated along with the first, second and third rotary shafts 335, 443 and 453. The chains 630 are configured to connect the driven gears 620 with the driving gear 611 of the driving motor 610 to transmit a driving force.

Here, each driven gear 620 is provided with a cradle recess 621 in one axial face thereof. A coupling member 650 is inserted into the cradle recess 621. The coupling member 650 includes first and second pressing members 651 and 652, an inserting member 653, and fastening members 654.

The first pressing member 651 is divided into a large number of first pressing members along a circumference in the cradle recess 621, and has a first slope 651a inclined in a radial outward direction such that the inner circumference thereof is in contact with the outer circumference of the first, second or third rotary shaft 335, 443 or 453.

The second pressing member 652 is divided into a large number of second pressing members along a circumference in the cradle recess 621, and has a second slope 652a inclined in a radial inward direction corresponding to the first slope 651a such that the outer circumference thereof is in contact with the inner circumference of the cradle recess 621.

The inserting member 653 has a ring shape, is inserted between the first and second slopes 651a and 652a, and is provided with one or more fastening holes along its circumference.

As in FIG. 13, the fastening members 654 are configured to push the first and second pressing members 651 and 652 in opposite directions when inserted through the fastening holes and fastened between the first and second pressing members 651 and 652, and thus to press the cradle recess 621 and the first, second or third rotary shaft 335, 443 or 453.

In detail, when each fastening member 654 is inserted into the corresponding fastening hole of the inserting member 653, an end of each fastening member 654 enters between the first and second slopes 651a and 652a. At this time, the first and second pressing members 651 and 652 are pushed in the opposite directions to each other, thereby pressing the inner circumference of the cradle recess 621 and the outer circumference of the first, second or third rotary shaft 335, 443 or 453. Thus, it is possible to variably adjust a position of the first, second or third rotary shaft 335, 443 or 453.

The tension adjusting gear 640 is installed to be rotatable in the forward and backward directions of the body 100, and configured to adjust tension in close contact with one of the chains 630. Alternatively, a plurality of tension adjusting gears may be installed.

Here, the body 100 is provided with one or more long holes 110 in one sidewall thereof which are directed to the installed directions of the chains 630. Thus, the tension adjusting gear(s) 640 may be installed to be able to be positioned in the long holes 110 by the fastening members 654.

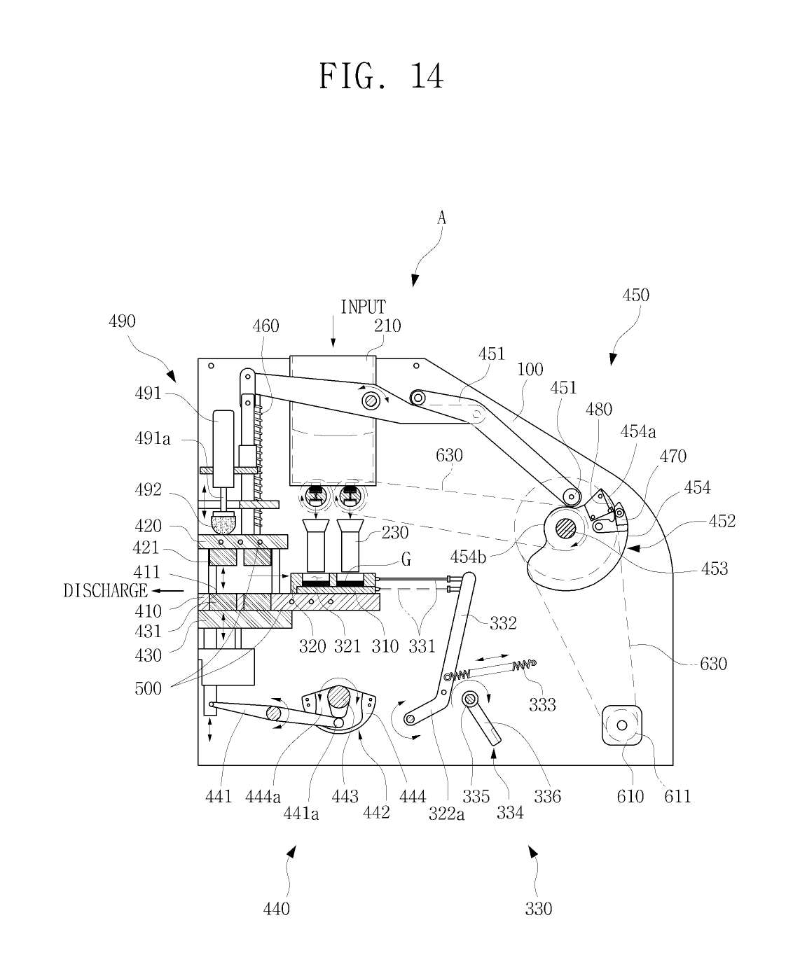

Hereinafter, an operational sequence of the cereal puff producing apparatus according to the present invention will be described below with reference to FIGS. 14 through 21.

First, as in FIG. 14, when the cereal G is input into the hopper 210, the cereals G falling down from the discharge ports 210a formed in the lower portion of the hopper 210 enter the cereal containing recesses 221 of the cereal feed shaft 220. The cereals G contained in the cereal containing recesses 221 are guided along the small or large number of cereal guide holes 230 formed in the cereal guide frame 231 or 231a, and are contained in the cereal containing holes 321 of the second slide member 320.

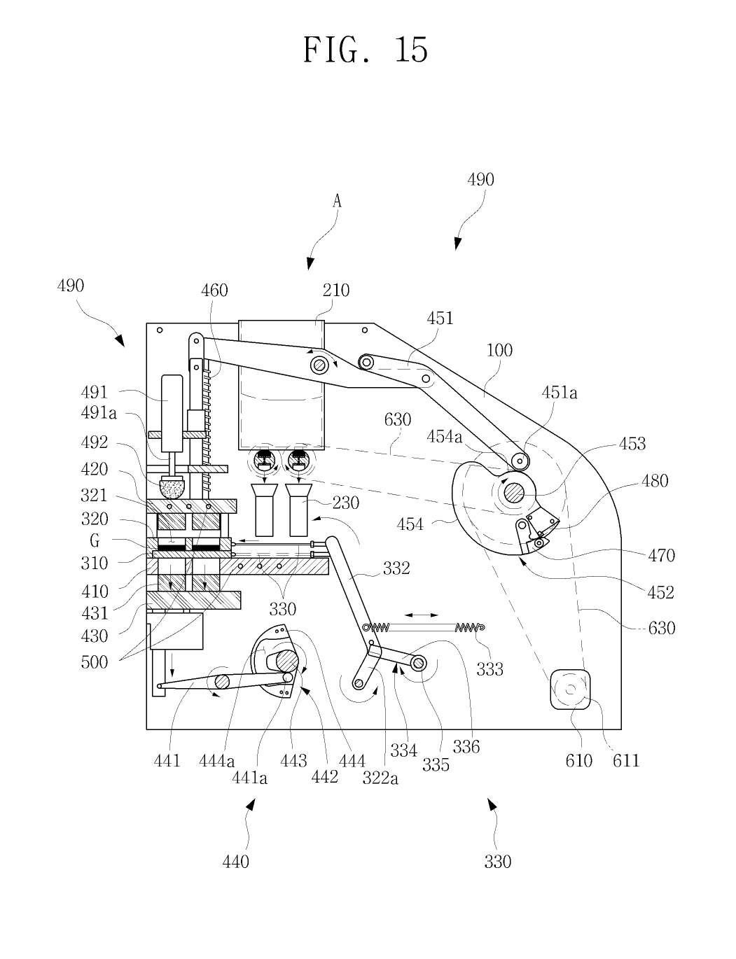

Next, as in FIG. 15, the first and second slide members 310 and 320 slide together toward the front of the body 100. Here, the forward movement of the first and second slide members 310 and 320 is enabled by the second actuating rod 332 in cooperation with the rotation of the first rotary member 334.

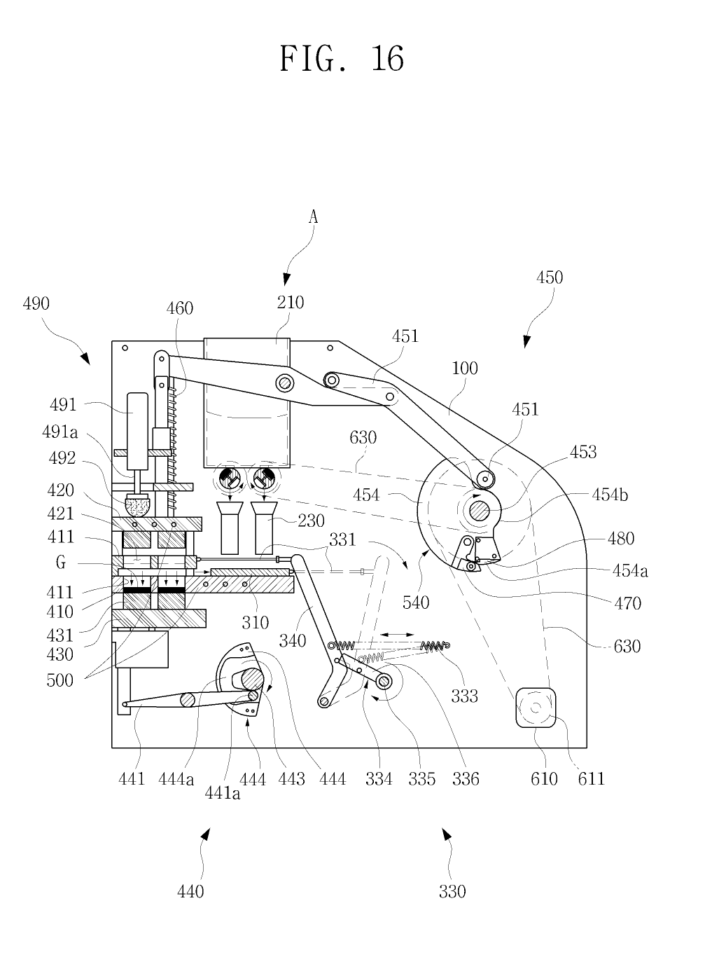

Subsequently, as in FIG. 16, the first slide member 310 is returned in the backward direction first. Here, the cereals G contained in the cereal containing holes 321 of the second slide member 320 are discharged down to the cereal processing holes 411 of the lower mold 410. In this case, the liftable member 430 is raised, and the second pressurizing pads 431 formed on the liftable member 430 serve as bottom surfaces such that the cereals do not leak from the cereal processing holes 411 in the downward direction.

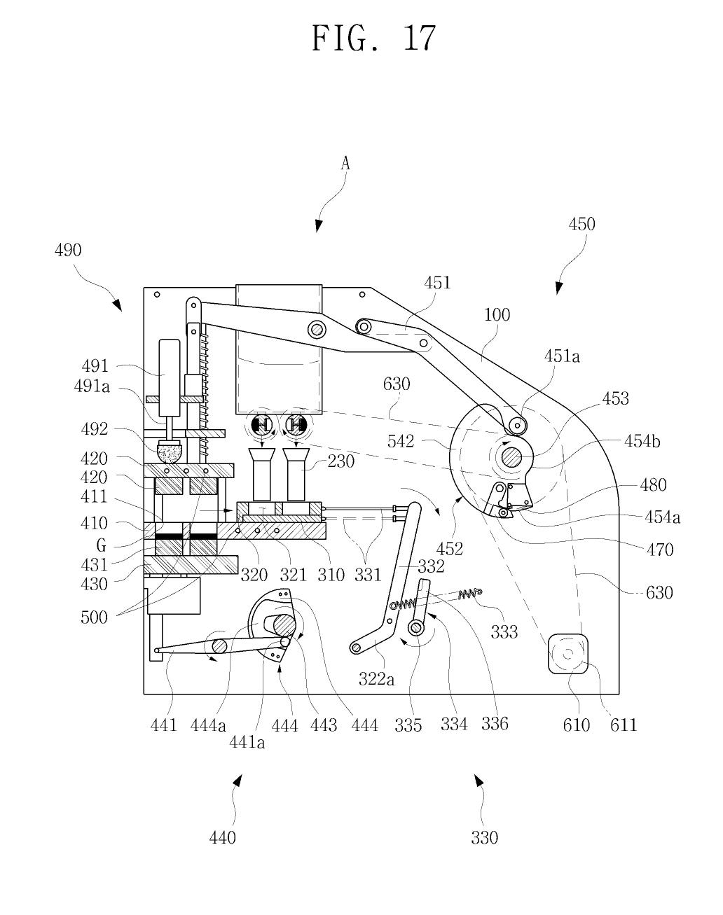

Then, as in FIG. 17, the second slide member 320 is returned in the backward direction after the cereals G are completely discharged.

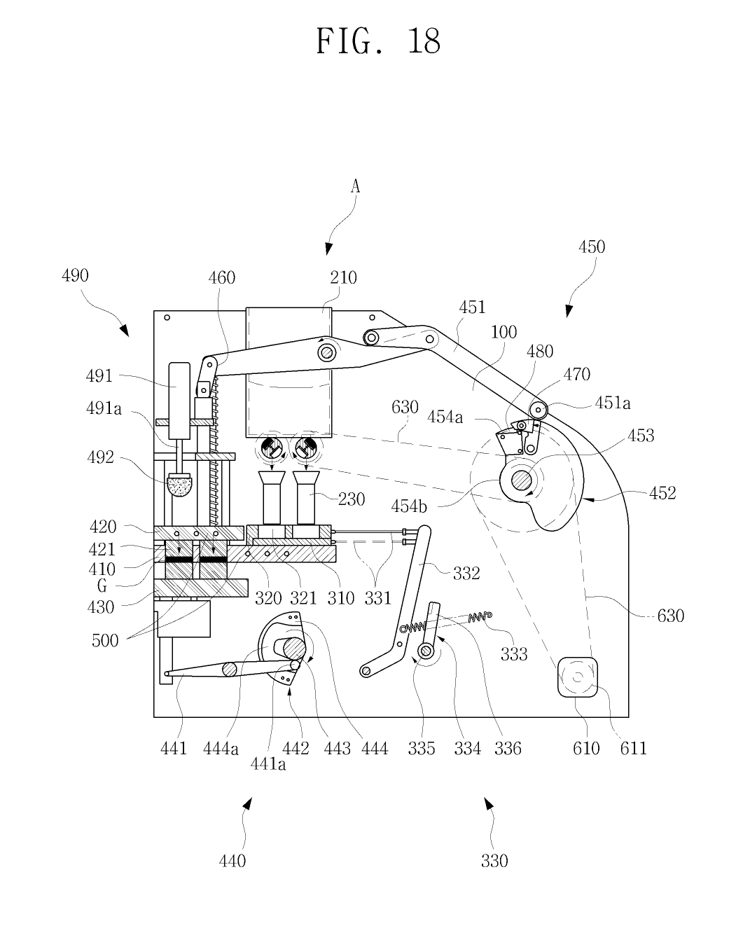

Next, as in FIG. 18, the upper mold 420 is lowered, the first pressurizing pads 421 protruding from the upper mold 420 pressurize the cereals contained in the cereal processing holes 411.

Here, the upper mold 420 and the lower mold 410 are supplied with a predetermined amount of heat by the heating unit 500. The cereals G contained in the cereal processing holes 411 are subjected to a predetermined pressure by the supplied heat and the pressurization of the first pressurizing pads 421. Simultaneously, the second elastic member 460 supporting the upper mold 420 is compressed.

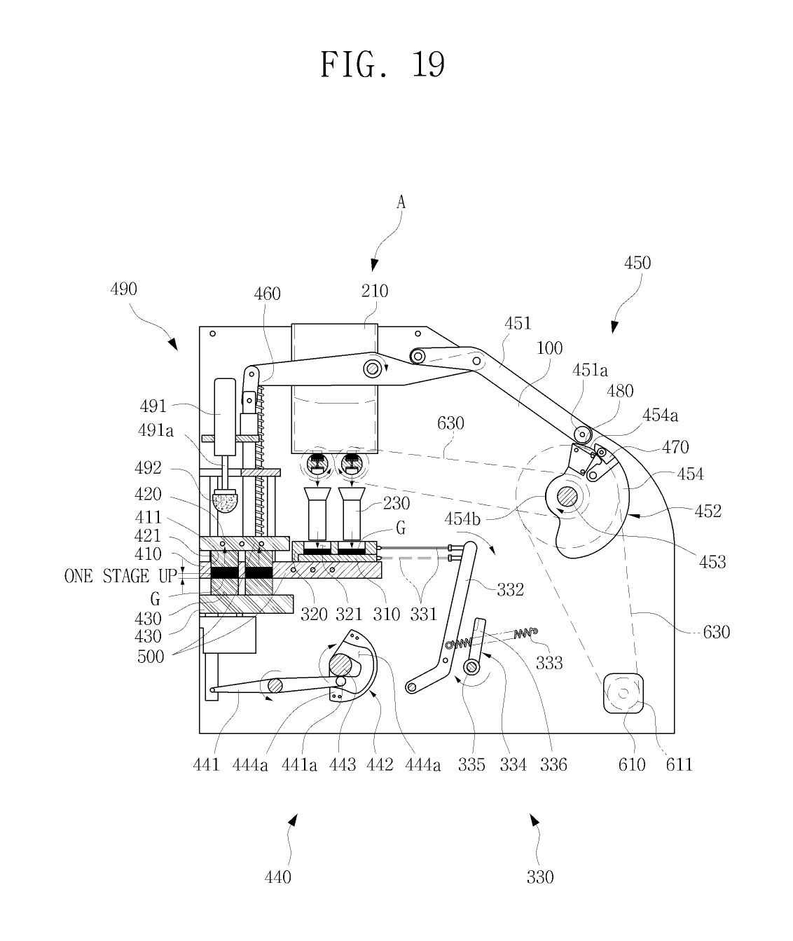

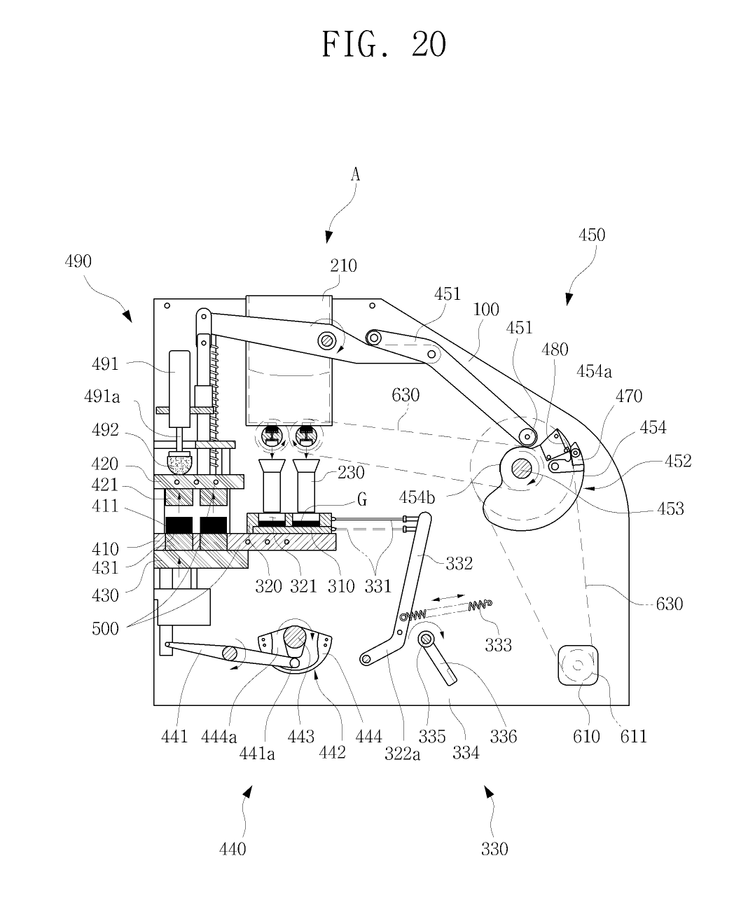

Next, as in FIG. 19, as the upper mold 420 is raised once, the cereals G are primarily expanded. As in FIG. 20, as the upper mold 420 is rapidly raised to its original position, the cereals G are secondarily expanded. As a result, the cereals G are puffed into cereal puffs in the cereal processing holes 411.

At this time, the liftable member 430 is raised, and the second pressurizing pads 431 protruding from the liftable member 430 are raised until the cereal puffs are matched with the upper surfaces of the cereal processing holes 411.

In other words, the second pressurizing pads 431 of the liftable member 430 are located below to serve as the bottom surfaces of the cereal processing holes 411 before the first and second slide members 310 and 320 move in the forward direction at the same time.

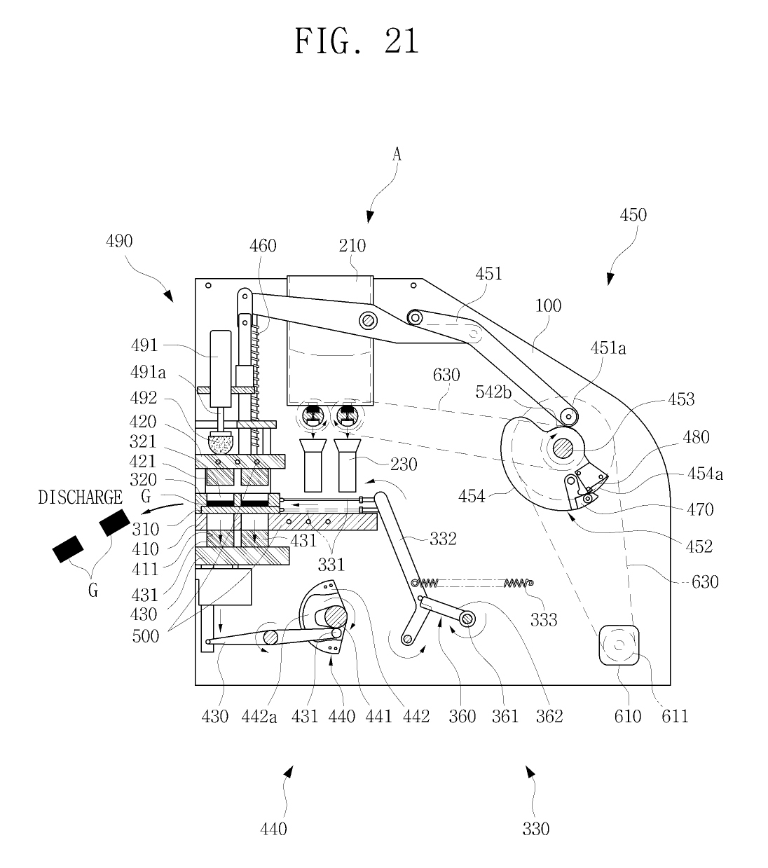

Finally, as in FIG. 21, the first and second slide members 310 and 320 move together in the forward direction in the same manner as the previous operational sequence.

Here, the cereal puffs are pushed and discharged out of the body 100 by the first and second slide members 310 and 320 moving together in the forward direction.

Consequently, it is possible to expand the cereals G in multiple stages, to puff the cereals into numerous cereal puffs having a uniform shape, and thus to improve a quality of the processed cereal puffs. Further, since the processed cereal puffs can be discharged in a constant direction, it is easy to collect the processed cereal puffs.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. An apparatus for producing cereal puffs, comprising:
a cereal feed unit located at an upper portion of a body and dispensing cereals by a predetermined amount;
a cereal transfer unit located in the body, containing the cereals dispensed by the cereal feed unit, moving and discharging the cereals to and from a processing position, and sliding in forward and backward directions such that, when the cereals discharged from the processing position are processed and puffed into the cereal puffs, the cereal puffs are pushed and discharged to the outside;
a cereal processing unit located on a front side of the body, moving up and down in multiple stages to receive the cereals when the cereals are transferred to and discharged from the processing position by the cereal transfer unit, and puffing the cereals through heat and pressure into a plurality of cereal puffs having a predetermined size; and
a driving unit installed on the body, driven under control of a controller, and sequentially driving the cereal feed unit, the cereal transfer unit, and the cereal processing unit.

2. The apparatus according to claim 1, wherein the cereal feed unit includes:
a hopper located at the upper portion of the body, allowing the cereals to be input thereinto, and having a plurality of discharge ports in a lower surface thereof to dispense the cereals by a predetermined amount; and
a cereal feed shaft rotatably installed on a lower side of the hopper and having a plurality of cereal containing recesses, each of which contains a predetermined amount of cereals discharged from the corresponding discharge port and then discharges the cereals to the cereal transfer unit.

3. The apparatus according to claim 2, wherein the hopper has a small or large number depending on the size and number of the cereal puffs into which the heated and pressurized cereals are puffed, and the cereal feed shaft has a number corresponding to the hopper.

4. The apparatus according to claim 2, wherein each cereal containing recess is fitted with a capacity adjusting member having a predetermined thickness such that the capacity of the cereals can be adjusted.

5. The apparatus according to claim 4, wherein the capacity adjusting member is fastened to a bottom of the cereal containing recess by a fastening member.

6. The apparatus according to claim 2, further comprising a cereal guide frame installed below the cereal feed shaft to guide the cereals, which are discharged from the cereal containing recesses, down to transfer the cereals to the cereal transfer unit,
wherein the cereal guide frame includes a small or large number of cereal guide holes such that, when the heated and pressurized cereals are puffed into the cereal puffs, the size and number of the cereal puffs are set.

7. The apparatus according to claim 6, wherein the cereal guide frame having the small or large number of cereal guide holes is selectively applied depending the size and number of the cereal puffs.

8. The apparatus according to claim 1, wherein the cereal transfer unit includes:
a first slide member capable of sliding in forward and backward directions of the body;
a second slide member installed on top of the first slide member and having cereal containing holes vertically opened to contain the cereals fed by the cereal feed unit; and
a first actuator simultaneously sliding the first and second slide members in the forward direction by means of a driving force of the driving unit, and returning the first slide member in the backward direction and then the second slide member from which the cereals are discharged in the backward direction.

9. The apparatus according to claim 8, wherein the cereal containing holes have a number corresponding to a small or large number of cereal guide holes.

10. The apparatus according to claim 8, wherein the first actuator includes:
a pair of first actuating rods connected to the respective first and second slide members at first ends thereof and installed to be movable in forward and backward directions;
a pair of second actuating rods rotatably installed on the body via an axle and hinged with the second ends of the pair of first actuating rods at first ends thereof;
a pair of first elastic members connected to the pair of second actuating rods at first ends thereof and performing an elastic action such that the pair of second actuating rods are independently returned in the backward direction; and
a first rotary member raising and rotating the pair of second actuating rods in the forward direction and lowering one of the pair of second actuating rods first such that the first slide member is returned in the backward direction.

11. The apparatus according to claim 10, wherein the first rotary member includes a first rotary shaft, and a pair of first cams that are installed on the first rotary shaft to be eccentrically rotated, simultaneously raise the pair of second actuating rods when rotated, and cause one having a small thickness in a rotational direction to lower one of the pair of second actuating rods first to return the first slide member in the backward direction first.

12. The apparatus according to claim 1, wherein the cereal processing unit includes:
a lower mold having cereal processing holes for receiving the cereals discharged from the cereal transfer unit;
an upper mold liftably installed on an upper side of the lower mold and having first pressurizing pads to pressurize the cereals received in the cereal processing holes;
a liftable member having second pressurizing pads that are installed to be liftable from a lower portion of the lower mold into the cereal processing holes, serve as bottom surfaces of the cereal processing holes when lowered, and cause the processed cereals to be located above the cereal processing holes when raised;
a second actuator moving up and down the liftable member by means of a driving force of the driving unit; and
a third actuator lowering the upper mold and then raising and returning the upper mold in multiple stages by means of a driving force of the driving unit.

13. The apparatus according to claim 12, wherein the cereal processing holes have a number corresponding to a small or large number of cereal containing holes, and the first and second pressurizing pads have a number corresponding to the cereal processing holes.

14. The apparatus according to claim 12, wherein the upper mold is elastically supported by a second elastic member, and is returned upward by the second elastic member.

15. The apparatus according to claim 12, wherein the second actuator includes:
a third actuating rod installed to be rotatable in the forward and backward directions, hinged to the liftable member at a first lengthwise end thereof, and having a guide axle(s) protruding from one or both axial faces of the second end thereof opposite the first end thereof; and
a second rotary member installed to be rotatable in the forward and backward directions and guiding the guide axle to move the actuating rod in upward and downward directions when rotated.

16. The apparatus according to claim 15, wherein the second rotary member includes:
a second rotary shaft installed to be rotatable in the forward and backward directions; and
a second cam installed on the second rotary shaft to be eccentrically rotated and having a guide slot(s), which has a predetermined length in a rotational direction, in one or both axial faces thereof in order to guide the guide axle to move the third actuating rod in upward and downward directions when rotated.

17. The apparatus according to claim 12, wherein the third actuator includes:
a fourth actuating rod installed to be rotatable in the forward and backward directions, hinged to the upper mold at a first lengthwise end thereof, and moving the upper mold in upward and downward directions; and
a third rotary member installed to be rotatable in the forward and backward directions, raising the second lengthwise end of the fourth actuating rod to lower the upper mold when rotated, and then lowering the fourth actuating rod in multiple stages to raise and return the upper mold in multiple stages.

18. The apparatus according to claim 17, wherein the fourth actuating rod is coupled with a rotatable roller at a second end thereof.

19. The apparatus according to claim 17, wherein the third rotary member includes:
a third rotary shaft installed to be rotatable in the forward and backward directions; and
a third cam installed on the third rotary shaft to be eccentrically rotatable and having first and second steps that are continuously formed along a circumference thereof in order to lower the second lengthwise end of the fourth actuating rod, which is raised by the eccentric rotation, in multiple stages.

20. The apparatus according to claim 19, wherein the first step is configured to primarily lower the second lengthwise end of the fourth actuating rod, and the second step is formed deeper than the first step and is configured to secondarily lower the primarily lowered second lengthwise end of the fourth actuating rod.

21. The apparatus according to claim 19, wherein the first step is coupled with a pivotal member at one end thereof on the basis of a rotational direction to be eccentrically rotated in the opposite direction to the rotational direction.

22. The apparatus according to claim 21, wherein the pivotal member is configured to be rotated toward the first step to come into contact with the second lengthwise end of the fourth actuating rod, to lower the second lengthwise end of the fourth actuating rod toward the first step, and to be returned to an original position thereof by a dead load.

23. The apparatus according to claim 19, wherein the first step includes a first damping member on the bottom thereof to absorb a shock generated when the second lengthwise end of the fourth actuating rod is lowered.

24. The apparatus according to claim 1, wherein the cereal processing unit further includes a damping device that absorbs a shock caused by the upper mold when the upper mold is raised.

25. The apparatus according to claim 24, wherein the damping device includes a cylinder, on a lower portion of which a rod is retractably installed, and a second damping member installed on a lower end of the rod and contacting an upper face of the upper mold.

26. The apparatus according to claim 12, wherein the upper and lower molds are configured so that heating units subjected to temperature control by a controller are inserted thereinto.

27. The apparatus according to claim 1, wherein the driving unit includes:
at least one driving motor installed on the body and having a driving shaft on which a driving gear is installed;
a plurality of driven gears installed to be rotated along with the first, second and third rotary shafts;
chains connecting the driven gears with the driving gear of the driving motor to transmit a driving force; and
at least one tension adjusting gear installed to be rotatable in the forward and backward directions and adjusting tension in close contact with one of the chains.

28. The apparatus according to claim 27, wherein the body includes at least one long hole in one sidewall thereof which is directed to the installed directions of the chains, and the tension adjusting gear is installed to be able to be positioned in the long hole by fastening members.

29. The apparatus according to claim 27, wherein each driven gear includes a cradle recess in one axial face thereof, into which a coupling member is inserted.

30. The apparatus according to claim 29, wherein the coupling member includes:
a first pressing member divided into a large number of first pressing members along a circumference in the cradle recess and having a first slope inclined in a radial outward direction such that an inner circumference thereof is in contact with an outer circumference of the first, second or third rotary shaft;
a second pressing member divided into a large number of second pressing members along a circumference in the cradle recess and having a second slope inclined in a radial inward direction corresponding to the first slope such that an outer circumference thereof is in contact with an inner circumference of the cradle recess;
an inserting member having a ring shape, inserted between the first and second slopes, and including one or more fastening holes along a circumference thereof; and
fastening members configured to push the first and second pressing members in opposite directions when inserted through the fastening holes and fastened between the first and second pressing members, and to press the cradle recess and the first, second or third rotary shaft.
